(19) United States
(12) Patent Application Publication
(10) Pub. No.: US 2011/0273149 A1
(43) Pub. Date: Nov. 10, 2011

(54) AUTOMATIC VOLTAGE REGULATOR AND TOROIDAL TRANSFORMER

(75) Inventor: Myung Hwan Lee, Seoul (KR)

(73) Assignees: CSKK (HKG) LIMITED, Hong Kong (CN); Myung Hwan Lee, Seoul (KR)

(21) Appl. No.: 13/000,902

(22) PCT Filed: Jan. 20, 2009
(86) PCT No.: PCT/KR2009/000290

§ 371 Date: Dec. 22, 2010

(51) Int. Cl. G05F 1/14

(52) U.S. Cl. 323/255

(57) ABSTRACT

The present invention relates to an automatic voltage regulator and a toroidal transformer, comprising: a main winding; a primary field winding excited in the main winding; a first switch unit for selectively connecting one end of the primary field winding to either a reference potential or the output terminal; a plurality of secondary field windings excited in the main winding; a second switch unit for selectively switching so that the plurality of secondary field windings are selectively connected to the primary field winding serially; a third switch unit for selectively connecting an end of a serial connection generated by selectively connecting the primary field winding and the secondary field windings to either the reference potential or the input terminal; and a control unit which regulates the level of an output voltage output to the output terminal.

### TECHNICAL FIELD

The present invention relates to an automatic voltage regulator and a toroidal transformer, particularly to an automatic voltage regulator capable of precisely controlling the output voltage level and a toroidal transformer used for the same.

### BACKGROUND

An automatic voltage regulator using a toroidal autotransformer can be implemented with various regulator windings. However, the output voltage of such a regulator is always determined by the winding of its primary and secondary coils. Thus, in order to output various voltages, an automatic voltage regulator using a toroidal autotransformer is designed to wind coils according to the desired voltage or have several output taps.

For example, as illustrated in FIG. 1, an autotransformer can be designed to have a plurality of taps (a, b, c) on a field winding (200) excited in a main winding (100) so as to output various voltage levels. If the toroidal autotransformer is so designed that in case where 220V is applied to the main winding (100), 20V is applied to each end of the main winding (100) and each tap of the field winding (200) reduces the voltage by 5V, the toroidal autotransformer can supply 200V from the first tap (a), 205V from the second tap (b), and 210V from the third tap (a), to an output terminal.

As such, conventional automatic voltage regulators supply discrete output voltages with a large deviation between the voltages. For example, in the example as described above, each of the output voltages with a deviation of 5V, i.e., each of 200V, 205V and 210V, is selectively supplied. Accordingly, conventional automatic voltage regulators cannot provide precise voltage control.

As such, conventional automatic voltage regulators, providing low precision, are very inconvenient for users. For example, in the case of a high-story apartment, there is a large deviation in the system voltage provided to a consumer between low floors and high floors. The floors of a high-story apartment are classified into floors where the voltage needs to be reduced to save power and floors where the voltage needs to be increased so that a stable voltage can be supplied. However, conventional automatic voltage regulators are not capable of supplying voltage levels with such a large deviation while controlling the voltages precisely, and accordingly users have suffered great inconvenience.

In contrast, the present invention provides an automatic voltage regulator capable of precisely controlling the voltage level and thereby supplying an appropriate voltage.

Meanwhile, in order for a conventional automatic voltage regulator to operate in a power electronic system, complex features such as a main transformer, excitation transformer, detection transformer, highly sensitive effective value detection circuit, high speed A/D transform circuit, triac switching circuit, etc. are required. As a result, conventional automatic voltage regulators have such high prices that they are used in a special case such as an experiment requiring expensive laboratory equipments. Thus, a general user cannot afford such regulators, and thus the conventional regulators do not have marketability.

In addition, because such complex devices cannot operate normally if the frequency and level of a system voltage changes, conventional automatic voltage regulators have to be manufactured in consideration of electricity environment.

In contrast, the automatic voltage regulator of the present invention has a simple structure which does not use a power semiconductor circuit, and thus can control voltage precisely regardless of electricity environment.

Meanwhile, the reason why conventional automatic voltage regulators selectively output discrete output voltage levels with a large deviation between them is because the regulators output an output voltage from a tap fixedly placed on a secondary coil.

The reason for the technical limitation is because a very limited range of winding methods have been used for a toroidal core. In the current process of producing a toroidal core, a main winding is wound on a toroidal core, and then a coil of a certain thickness is wound on the main winding to form field windings where input/output taps are formed. If a non-conductive coil is inserted between the main winding and field windings of a toroidal core, problems occur such as generation of fumes from the inserted coil. Thus, in this process, only field windings serially connected by taps and a main winding are used.

The present invention is to improve such a winding method for conventional toroidal cores and thereby to output various levels of inductive voltage.

### SUMMARY

The present invention was conceived to solve said problems of conventional technology. An objective of the present invention is to provide an automatic voltage regulator and toroidal transformer capable of outputting continuous voltage levels and thereby controlling voltages precisely.

Another objective of the present invention is to provide an automatic voltage regulator with a simple structure capable of operating in various electricity environments.

The objectives of the present invention can be achieved by an automatic voltage regulator according to the present invention for converting an input voltage applied to an input terminal and outputting the converted input voltage to an output terminal, comprising: a main winding having one end thereof connected to the input terminal and the other end thereof connected to the output terminal; a primary field winding excited in the main winding; a first switch unit for selectively connecting one end of the primary field winding to either a reference potential or the output terminal; a plurality of secondary field windings excited in the main winding; a second switch unit for selectively switching so that the plurality of secondary field windings are selectively connected to the primary field winding serially, and that one or more of the plurality of secondary field windings are serially connected to each other to be serially connected to the other end of the primary field winding when the one or more of the plurality of secondary field windings are connected to the other end of the primary field winding; a third switch unit for selectively connecting an end of a serial connection generated by selectively connecting the primary field winding and the secondary field windings to either the reference potential or the input terminal; and a control unit which regulates the level of an output voltage output to the output terminal by switching control of the first switch unit, the second switch unit, and the third switch unit.

Preferably, said automatic voltage regulator further comprises a level measurement unit for measuring the level of the input voltage inputted to the input terminal, and wherein the control unit is configured to: if a predetermined target voltage is higher than the level of the input voltage measured by the level measurement unit, control the first switch unit to connect the one end of the primary field winding to the reference potential, control the second switch unit to compensate for a voltage difference between the predetermined target voltage and the measured level of the input voltage, and control the third switch unit to connect the end of the serial connection to the input terminal, and if the predetermined target voltage is lower than the level of the input voltage, control the first switch unit to connect the one end of the primary field winding to the output terminal, control the second switch unit to compensate for the voltage difference, and control the third switch unit to connect the end of the serial connection to the reference potential.

In addition, the objectives of the present invention can also be achieved by another embodiment of the present invention, an automatic voltage regulator for converting an input voltage applied to an input terminal and outputting the converted input voltage to an output terminal, comprising: a main winding; a first switch unit for connecting one end of the main winding to either the input terminal or the output terminal; a second switch unit for connecting the other end of the main winding to either the input terminal or the output terminal a primary field winding excited in the main winding and having one end connected to the output terminal; a plurality of secondary field windings excited in the main winding; a third switch unit for selectively switching so that the plurality of secondary field windings are selectively connected to the primary field winding serially, and that one or more of the plurality of secondary field windings are serially connected to each other to be serially connected to the other end of the primary field winding when the one or more of the plurality of secondary field windings are connected to the other end of the primary field winding; and a control unit which regulates the level of an output voltage output to the output terminal by switching control of the first switch unit, the second switch unit, and the third switch unit.

Preferably, said automatic voltage regulator further comprises a level measurement unit for measuring the level of the input voltage inputted to the input terminal, and wherein the control unit is configured to: if a predetermined target voltage is higher than the level of the input voltage measured by the level measurement unit, control the first switch unit to connect the one end of the main winding to the output terminal, control the second switch unit to connect the other end of the main winding to the input terminal, and switch control the third switch to compensate for a voltage difference between the predetermined target voltage and the measured level of the input voltage, and if the predetermined target voltage is higher than the level of the input voltage measured by the level measurement unit, control the first switch unit to connect the one end of the main winding to the input terminal, control the second switch unit to connect the other end of the main winding to the output terminal, and switch control the third switch to compensate for a voltage difference between the predetermined target voltage and the measured level of the input voltage.

Said automatic voltage regulator further comprises a user input unit for receiving the predetermined target voltage from the user, thereby providing user convenience.

In addition, said automatic voltage regulator of the present invention may be designed such that the main winding is wound on a toroidal core, the primary field winding is wound to surround the main winding, and that the secondary field windings are wound to surround the primary field winding. The winding method of the present invention may also be modified such that the main winding is wound on a toroidal core, the primary field winding is wound on the toroidal core to surround the main winding, one part of the plurality of secondary field windings are wound to surround the main winding by partitioning the primary field winding and the toroidal core, and that the other part of the plurality of secondary field windings is wound to surround the primary field winding and the one part of the plurality of secondary field windings, which surround the main winding. In addition, said automatic voltage regulator of the present invention may also be designed such that the plurality of secondary field winding are wound in part on a second toroidal core.

Meanwhile, in order to make the use of a separate autotransformer for decreasing voltage meaningful, said automatic voltage regulator of the present invention should be designed such that the sum of auxiliary voltages induced by exciting the plurality of secondary field windings is lower than the potential applied across the main winding.

In addition, preferably, in said automatic voltage regulator of the present invention, a selective addition using switching control of auxiliary voltages induced by exciting the plurality of secondary field windings may represent a voltage level lower than the potential applied across the main winding, and the voltage level corresponds to an integer number.

In addition, said automatic voltage regulator of the present invention may be designed such that the plurality of secondary field windings are wound to represent all the integer numbers of turns equal to or less than the maximum number of turns added by combining each of the turns of the plurality of secondary field windings. In this case, it is possible to adjust the number of turns serially connected by the secondary field windings down to 1 [turn], which makes it possible to provide precise voltage control. According to the present invention, for example, the number of turns of at least a part of the plurality of secondary field windings is 2ⁿ⁻¹×10^{m-1}, wherein 1≦n≦4, m≧1, and n and m may be integer numbers.

Meanwhile, preferably, said automatic voltage regulator of the present invention further comprises a fourth switch unit for switching the input terminal and the output terminal, and if a voltage difference between the predetermined target voltage and the level of the input voltage is within a predetermined permissible range, the control unit turns on the fourth switch unit to bypass the input voltage to the output terminal.

Said switch units are implemented with relays, which makes it possible to provide a circuit configured in a simple manner operable in various electricity environments.

In addition, the objectives of the present invention can also be achieved by another embodiment of the present invention, an automatic voltage regulator for converting an input voltage applied to an input terminal and outputting the converted input voltage to an output terminal, comprising: a main winding having one end thereof connected to the input terminal and the other end thereof connected to the output terminal; a primary field winding excited in the main winding and having one end thereof connected to the output terminal; a plurality of secondary field windings excited in the main winding; a switch unit for selectively switching so that the plurality of secondary field windings are selectively connected to the other end of the primary field winding serially, and that one or more of the plurality of secondary field windings are serially connected to each other to be serially connected to the other end of the primary field winding when the one or more of the plurality of secondary field windings are connected to the other end of the primary field winding; and a control unit which regulates the level of an output voltage output to the output terminal by switching control of the switch unit.

In addition, the objectives of the present invention can also be achieved by another embodiment of the present invention, an automatic voltage regulator for converting an input voltage applied to an input terminal and outputting the converted input voltage to an output terminal, comprising: a main winding having one end thereof connected to the input terminal and the other end thereof connected to the output terminal; a primary field winding excited in the main winding and having one end thereof connected to a reference potential; a plurality of secondary field windings excited in the main winding; a switch unit for selectively switching so that the plurality of secondary field windings are selectively connected to the other end of the primary field winding serially, and that one or more of the plurality of secondary field windings are serially connected to each other to be serially connected to the other end of the primary field winding when the one or more of the plurality of secondary field windings are connected to the other end of the primary field winding; and a control unit which regulates the level of an output voltage output to the output terminal by switching control of the switch unit.

Said automatic voltage regulators may be designed such that the main winding is wound on a toroidal core, the primary field winding is wound to surround the main winding, and the secondary field windings are wound to surround the primary field winding. Meanwhile, unlike this, said automatic voltage regulators may also be designed such that the main winding is wound on a toroidal core, the primary field winding is wound on the toroidal core to surround the main winding, one part of the plurality of secondary field windings are wound to surround the main winding by partitioning the primary field winding and the toroidal core, and the other part of the plurality of secondary field windings is wound to surround the primary field winding and the one part of the plurality of secondary field windings, which surround the main winding.

Said automatic voltage regulator further comprises a level measurement unit for measuring the level of the input voltage inputted to the input terminal, and wherein the control unit is configured to switch control the switch unit so as to compensate for a voltage difference between a predetermined target voltage and the measured level of the input voltage.

In addition, the objectives of the present invention can also be achieved by another embodiment of the present invention, a transformer using a toroidal core comprising: a main winding wound on the toroidal core, and having one end to which an input voltage is inputted; a primary field winding wound on the toroidal core on which the main winding is wound, and excited in the main winding; a plurality of secondary field windings wound on the primary field winding, and excited in the main winding; a switch unit for selectively connecting the plurality of secondary field windings to the primary field winding serially; and a control unit for controlling switching operations of the switch unit.

In addition, the objectives of the present invention can also be achieved by yet another embodiment of the present invention, a transformer using a toroidal core comprising: a main winding wound on the toroidal core, and having one end to which an input voltage is inputted; a primary field winding wound on the toroidal core on which the main winding is wound, and excited in the main winding; a plurality of secondary field windings excited in the main winding, wherein one part of the plurality of secondary field windings are wound on an area where the primary field winding is not wound, and the other part of the plurality of secondary field windings are wound to surround the primary field winding and the one part of the plurality of secondary field windings; a switch unit for selectively connecting the plurality of secondary field windings to the primary field winding serially; and a control unit for controlling switching operations of the switch unit.

### BRIEF DESCRIPTION OF DRAWINGS

FIG. 1 is a schematic circuit drawing for illustrating a plurality of voltage levels being output from a plurality of taps of the excitation winding at the conventional autotransformer.

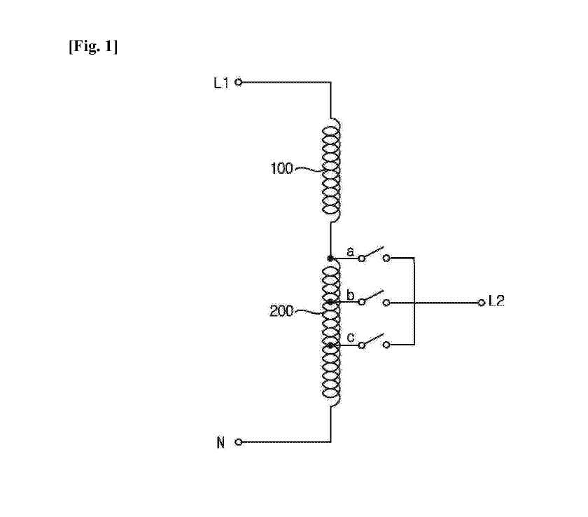

FIG. 2 is a schematic drawing of the internal structure of the automatic voltage regulator (AVR) according to the first embodiment of the present invention.

FIG. 3 is a modified example of the automatic voltage regulator (AVR) capable of regulating the output voltage to a voltage corresponding to 1 [turn].

FIG. 4 is a schematic drawing of the internal structure of the automatic voltage regulator according to the second embodiment of the present invention.

FIGS. 5-7 are schematic drawings for illustrating the winding method of the toroidal transformer according to the embodiment of the present invention.

### DETAILED DESCRIPTION

Hereinafter, embodiments of the present invention will be explained in more detail with reference to the attached drawings.

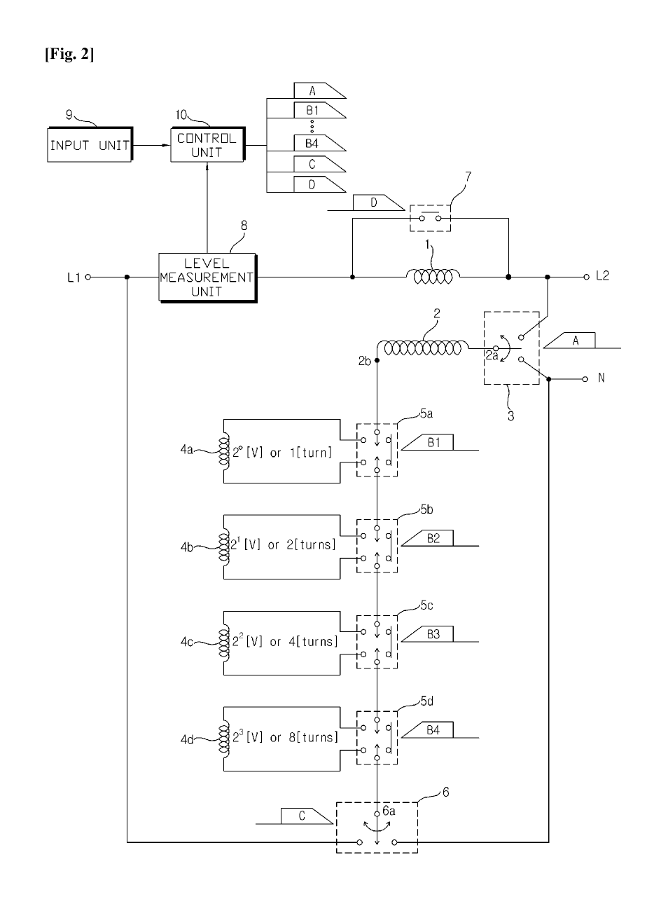

FIG. 2 is a schematic drawing of the internal structure of the automatic voltage regulator (AVR) according to the first embodiment of the present invention.

Referring to FIG. 2, the automatic voltage regulator comprises a main winding (1), a primary field winding (2), a first switch unit (3), a plurality of secondary field windings (4a˜4d), second switch units (5a˜5d), a third switch unit (6), a fourth switch unit (7), a level measurement unit (8), an input unit (9), and a control unit (10).

The main winding (1) has one end thereof connected to the input terminal (L1) receiving voltage and the other end thereof is connected to the output terminal (L2). For example, in the present embodiment, if a voltage of 220 [V] is inputted with respect to reference potential (N) as a potential inputted from the system to the input terminal (L1), the main winding (1) is wound to form a potential of 16 [V] at both ends of the main winding (1).

The primary field winding (2) is excited in the main winding (1), and one end (2a) thereof is selectively connected to either the output terminal (L2) or the reference potential (N). In the present embodiment, the primary field winding (2) is wound to form a potential of 204 [V] at both ends with respect to the input voltage of 220 [V] when one end (2a) is connected to the output terminal (L2). That is, it should be noted that the winding directions of the main winding (1) and the primary field winding (2) are determined so that it gets to have the same constitution as the polar autotransformer when one end (2a) of the primary field winding (2) is connected to the output terminal (L2).

The first switch unit (3) is for performing a switching operation so as to selectively connect one end (2a) of the primary field winding (2) to either the output terminal (L2) or the reference potential (N), and this can be implemented as various semiconductor devices, relays, etc., which are well known as switching devices. In the present embodiment, all switch units are realized using a relay so that they can be used in various electricity environments.

A plurality of secondary field windings (4a˜4d) are excited in the main winding (1), and selectively connected to the other end of the primary field winding (2) serially by the switching operation of the second switch units (5a˜5d). The count of secondary field windings is based on the turns connected to the other end of the primary field winding (2) and the present invention comprises a plurality of secondary field windings. The turn of each secondary field winding can be determined so that the induced voltage which is induced by being excited in the main winding (1) reaches a certain level.

That is, for example, each secondary field winding (4a˜4d) can be wound so that a potential of 2ⁿ⁻¹ [V] (n=1,2,3,4) is induced when 204 [V] is applied to both ends of the primary field winding (2). As illustrated in the drawings, the secondary field windings (4a˜4d) are switched respectively to the second switch units (5a˜5d) one to one, and when at least one secondary field winding (4a˜4d) is connected serially, the secondary field windings (4a˜4d) are connected serially to one another. When the secondary field windings (4a˜4d) are not connected serially, the second switch units (5a˜5d) are switched to bypass. When the number of secondary field windings increases, it is possible to regulate the secondary field windings so that they are wound to represent various voltage levels. For example, the secondary field windings can be formed in a combination where 1 [V] or 2 [V] is added to allow voltage levels corresponding to multiples of 2, multiples of 3, and various voltage levels in addition to it.

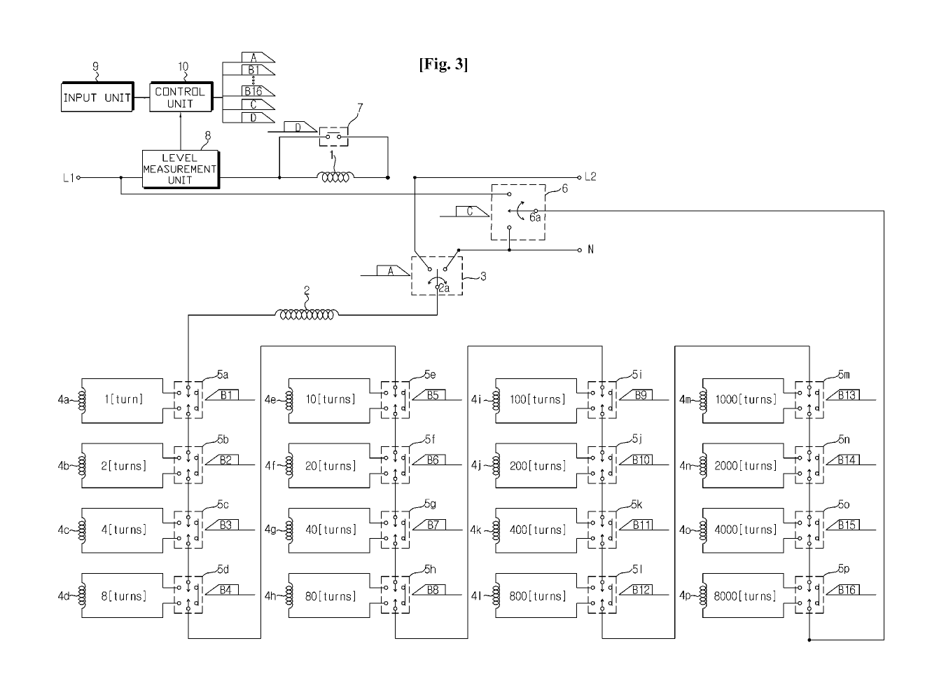

Meanwhile, it should be noted that the secondary field windings (4a˜4d) are not wound based on the size of induced voltage, but are formed based on the turns. For example, as illustrated in FIG. 3, a plurality of secondary field windings (4a˜4p) can be composed of 1, 2, 4, 8, 10, 20, 40, 80, 100, 200, 400, 800, 1000, 2000, 4000, 8000 [turns] according to 2ⁿ⁻¹×10^{m-1} (here, n is an integer of 1 to 4, and m is an integer of 1 or above). Accordingly, 1˜16665 [turns] can be selectively connected to the other end (2b) of the primary field winding (2) by selective switching of the second switch units (5a˜5p). This means that an induced voltage that can be formed by 1˜16665 [turns] can be added to the voltage induced in the primary field winding (2). Also, since the voltage can be regulated precisely down to the unit of 1 [turn], the present invention has an effect of precisely regulating the voltage to a voltage level corresponding thereto.

The size of the induced voltage varies according to the input voltage. However, voltage levels expressed by integers for certain input voltage can be determined experimentally according to the turns, and the input voltage can be compensated appropriately by selectively connecting turns serially according to the size of the voltage to be compensated.

As described above, secondary field windings (4a˜4d) can be counted according to the unit being switched, and each secondary field winding can be formed based on the size of induced voltage or turn, or a combination thereof.

A second switch units (5a˜5d) perform switching operation for selectively connecting a plurality of secondary field windings (4a˜4d) to the other end (2b) of the primary field winding (2). In particular, they can be implemented as four terminal relays (5a˜5d) performing switching operation with respect to each secondary field winding (4a˜4d).

For example, relays (5a˜5d) perform switching operation by the method of insulating the secondary field windings (4a˜4d) (hereinafter, “bypass mode”) and the method of adding an output voltage as much as the voltage induced to the secondary field windings (4a˜4d) by continuously connecting secondary field windings (4a˜4d) to the other end (2b) of the primary field winding (2) serially (hereinafter, “addition mode”).

A third switch unit (6) is for selectively connecting the other end (2b) of the primary field winding (2) or the end terminal (6a) of at least one secondary field winding (4a˜4d) connected thereto serially to either the input terminal (L1) or the reference potential (N).

It should be noted that the first switch unit (3) and third switch unit (6) are switched interlocked with each other. That is, when the first switch unit (3) connects one end (2a) of the primary field winding (2) to the reference potential (N), the third switch unit (6) connects the other end (2b) of the primary field winding (2) or the end terminal (6a) of the secondary field winding connected thereto serially to the input terminal (L1); when the first switch unit (3) connects one end (2a) of the primary field winding (2) to the output terminal (L2), the third switch unit (6) connects the other end (2b) of the primary field winding (2) or the end terminal (6a) of the secondary field winding (4a˜4d) connected thereto serially to the reference potential (N). Accordingly, owing to the charge in the relative winding directions of the main winding (1) and the primary field winding (2), additive polarity is changed to subtractive polarity, or subtractive polarity is changed to additive polarity; thus, it is possible to both boost and reduce the input voltage.

A fourth switch unit (7) is for directly connecting the input terminal (L1) to the output terminal (L2), or to insulate the input terminal (L1) from the output terminal (L2). It provides a path for bypassing for the input voltage when it intends to output the input voltage without changing it.

The level measurement unit (8) is for measuring the level of voltage inputted through the input terminal (L1), and measures, and then outputs, the peak value or effective value.

The input unit (9) is used for receiving, from the user, the target voltage intended to be output by the user, and can be implemented in various ways, such as a panel with an input switch such as an up-down key, a receiving device for receiving remote control command, etc. The target voltage may be a default value, a value inputted and stored by the user in advance, or a value updated during operation.

The control unit (10) compares the input voltage measured at the level measurement unit (8) with the target voltage, and activates the first to fourth switch units to perform switching control operation so that the input voltage reaches the target voltage.

The overall operation of the automatic voltage regulator illustrated in FIG. 2 will be explained, based on the operation of the control unit (10), according to the size of the target voltage and input voltage.

i) When the target voltage and the input voltage are the same:

The control unit operates so that the input voltage is output without change. Thus, the control unit (10) turns on the fourth switch unit (7) so that the input voltage bypasses the main winding (1) without change and is output through the output terminal (L2).

ii) When the target voltage is lower than the input voltage:

The control unit (10) controls the first to fourth switch units (3, 5, 6, 7) to decrease the voltage for output.

In particular, the control unit (10) turns off the fourth switch unit (7), controls the first switch unit (3) so that one end (2a) of the primary field winding (2) is connected to the output terminal (L2), and controls the third switch unit (6) so that the other end (2b) of the primary field winding (2) or the end terminal (6a) of at least one secondary field winding connected thereto serially is connected to the reference potential (N).

Meanwhile, the control unit (10) can regulate voltage precisely by selectively converting relays (5a˜5d) of the second switch units (5a˜5d) to the addition mode so as to compensate the difference between the level of the input voltage measured by the level measurement unit (8) and the target voltage.

The secondary field windings are wound so that when four secondary field windings input 220 [V], the potentials of 2ⁿ⁻¹[V](n=1,2,3,4) are respectively induced. The case where the input voltage is 220 [V] and the target voltage is 215 [V] will be explained as an example.

In this case, if all the relays (5a˜5d) of the second switch units (5a˜5d) are set to the bypass mode, the voltage of the output terminal (L2) is 204 [V]. Thus, in order to set the output voltage to the target voltage, the secondary field windings (4a˜4d) should be selectively converted to the addition mode.

215 [V] can be output in the following combination:

204 [V]+8 [V]+2 [V]+1 [V]=215 [V]

Thus, in order to activate the fourth secondary field winding (4d), second secondary field winding (4b), and first secondary field winding (4a) respectively corresponding to 8 [V], 2 [V], and 1 [V], the control unit (10) switches the fourth relay (5d), the second relay (5b), and the first relay (5a) to the addition mode, and switches the third relay (5c) to the bypass mode. In this way, the input voltage is decreased to the target voltage of 215 [V] for output to achieve the effect of saving power.

Here, it should be noted that 15 options consisting of 1, 2, 3, 4, . . . , 14, 15 [V], by selective combinations of secondary field windings, can be obtained, and all target voltages in the range of 204˜219 [V], wherein the target voltages are integers, can be covered in the present embodiment. Since voltage can be regulated precisely as such, it is possible to obtain a voltage very close to the target voltage. Also, considering the input voltage system actually used in each country, even if the input voltage is changed, it is possible to regulate the output voltage within a margin of error of 1 [V] at the maximum with respect to the target voltage.

Meanwhile, in the present embodiment, if four secondary field windings are respectively wound 1, 2, 4, 8 [turns], the output voltage would be 204 [V] plus induced voltage corresponding to 1˜15 [turns]. Accordingly, the induced voltage corresponding to the maximum 15 [turns] would determine the upper limit of voltage that can be output. In case of forming a plurality of secondary field windings (4a˜4d) based on the turns, a secondary field winding having various windings can be formed. For example, as illustrated in FIG. 3, a plurality of secondary field windings (4a˜4p) can be composed of 1, 2, 4, 8, 10, 20, 40, 80, 100, 200, 400, 800, 1000, 2000, 4000, 8000 [turns] according to 2ⁿ⁻¹×10^{m-1} (here, n is an integer of 1 to 4, and m is an integer of 1 or above), and since it is possible to selectively connect 1˜16665 [turns] serially, induced voltage corresponding to 16665 [turns] can be added.

In general, it is preferable for the voltage to be added by secondary field windings (4a˜4d) to cover the voltage applied to both ends of the main winding (1). If this is possible, it is possible to omit the fourth switch unit (7) as a bypass.

It should be noted that target voltage can be output by selectively connecting the turns serially according to the level of induced voltage required for compensation by experimentally determining the turns corresponding to the induced voltage.

Here, the voltage can be regulated precisely not based on 1 [V] unit, but based on the voltage corresponding to 1 [turn], and thus the accuracy is further improved.

Although it is not illustrated in FIG. 2, it is possible to control the second switch units (5a˜5d) so that the voltage becomes closest to the target voltage by measuring the level of the output voltage and have proper turns connected serially.

iii) When the target voltage is higher than the input voltage:

The input voltage should be raised to the target voltage.

Thus, the control unit (10) controls the first to fourth switch units (3, 5, 6, 7) to increase the input voltage for output.

To be specific, the control unit (10) turns off the fourth switch unit (7), controls the first switch unit (3) so that one end (2a) of the primary field winding (2) is connected to the reference potential (N), and controls the third switch unit (6) so that the other end (2b) of the primary field winding (2) or the end terminal (6a) of at least one secondary field winding (4a˜4b) connected thereto serially is connected to the input terminal (L1).

Meanwhile, the control unit (10) can regulate voltage accurately by selectively converting relays (5a˜5d) of the second switch units (5a˜5d) to the addition mode so as to compensate for the difference between the level of the input voltage measured by the level measurement unit (8) and the target voltage.

When four secondary field windings (4a˜4d) input 220 [V], the secondary field windings are wound so that the potentials of 2ⁿ⁻¹ [V](n=1,2,3,4) are respectively induced; the case where the input voltage is 220 [V] and the target voltage is 234 [V], that is the case where the voltage has to be raised by 14 [V], will be explained as an example.

In this case, the control unit (10) controls the second switch units (5a˜5d) so that a voltage of 14 [V] is added to the voltage of 16 [V] applied to both ends of the main winding (1) and to the voltage of 206 [V] induced by the primary field winding (2). That is, the second to fourth relays (5b˜5d) are switched to put the second to fourth secondary field windings (4b˜4d), except for the first secondary field winding (4a) where the induced voltage is 1 [V], in the addition mode, so that a voltage of 14 [V] can be added.

Meanwhile, as illustrated in FIG. 3, in case a plurality of secondary field windings (4a˜4p) are composed of 1, 2, . . . , 4000, 8000 [turns] according to 2ⁿ⁻¹×10^{m-1} (here, n is an integer of 1 to 4, and m is an integer of 1 or above), the second switch units (5a˜5p) is capable of selective control switching, so that the secondary field windings are connected serially as much as the turns that are experimentally found out to correspond to 14 [V].

Also, even in case the induced voltage and turns are not predetermined by experiment, it is possible to increase or decrease the turns connected serially after measuring the level of the output voltage and evaluating the measured value to find the appropriate turns.

As can be seen above, the automatic voltage regulator of the present invention can provide rated voltage by automatically raising the input voltage not only in an environment requiring power saving, but in an environment where the power supply is poor and the input voltage does not reach the rated voltage of an electric product.

The present invention can boost or decrease the output voltage by switching of the first switch unit (3) and third switch unit (6), and adjust the level of decrease or increase in the voltage by the switching of second switch units (5a˜5d) to the level of induced voltage corresponding to 1 [V] or 1 [turn].

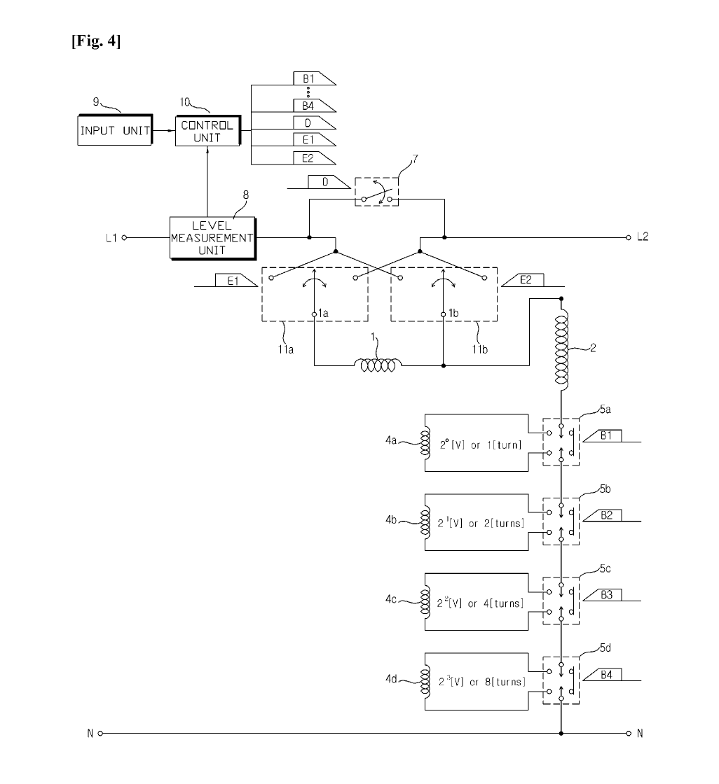

FIG. 4 is a schematic drawing of the internal structure of the automatic voltage regulator according to the second embodiment of the present invention. As can be seen, the automatic voltage regulator illustrated in FIG. 4 is very similar to that illustrated in FIG. 2.

Thus, it uses the same reference numerals as FIG. 2 to represent the same elements in the two drawings. The automatic voltage regulator according to the second embodiment of the present invention will be explained based on the differences of FIG. 4 from FIG. 2.

Referring to FIG. 4, the main winding (1) is not fixedly connected to the input terminal (L1) and output terminal (L2). In particular, one end (1a) of the main winding (1) is connected to any one of the input terminal (L1) and output terminal (L2), and the other end (1b) is connected to either the input terminal (L1) or the output terminal (L2), by the switching operation of the fifth switch units (11a, 11b).

In contrast, the other end (2b) of the primary field winding (2) or the end terminal of at least one secondary field windings (4a˜4d) connected thereto serially is fixedly connected to the reference potential (N).

That is, in FIG. 2, the first and third switch units (6) are designed to convert the relative winding directions of the main winding (1) and the primary field winding (2) with respect to the output terminal (L2). However, in the present embodiment, both ends of the fifth switch units (11a, 11b) are cross-connected to either the input terminal (L1) or the output terminal (L2).

In particular, if one end (1a) of the main winding (1) is connected to the input terminal (L1) and the other end (1b) is connected to the output terminal (L2), the winding directions of the main winding (1) and the primary field winding (2) seen from the output terminal (L2) are the same, and the input voltage is output after being reduced. In contrast, if one end (1a) of the main winding (1) is connected to the output terminal (L2) and the other end (1b) is connected to the input terminal (L1), the winding directions of the main winding (1) and the primary field winding (2) seen from the output terminal (L2) are different, and the input voltage is output after being raised.

As can be seen above, boosting or decreasing the voltage by changing the winding direction seen from the output terminal (L2) is the same as obtaining a boosted voltage at the input terminal (L1) by applying an input voltage to the output terminal (L2) where the input voltage applied to the input terminal (L1) of the autotransformer turns into a reduced voltage at the output terminal (L2).

Thus, the first and second embodiments differ in the switching method of selecting whether to raise or reduce voltage, but they are the same in the method of compensating the voltage difference and the method for determining the size.

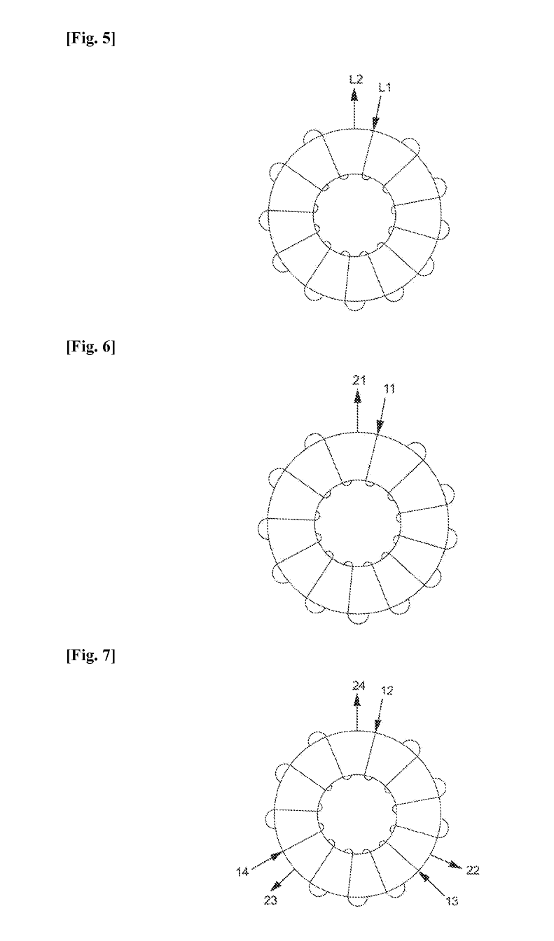

FIGS. 5˜7 are schematic drawings illustrating the winding method of the toroidal transformer according to an embodiment of the present invention.

Referring to FIG. 5, the main winding (1) of FIGS. 2˜4 is wound on a toroidal core.

Referring to FIG. 6, coil is wound to form the primary field winding (2) with the main winding (1) wound on a toroidal core.

Referring to FIG. 7, coil is wound to form the corresponding secondary field windings (4a˜4d) so as to form auxiliary voltage corresponding to 2ⁿ [V] on the primary field winding (2).

As stated above, the conventional toroidal transformer has the primary field winding (2) wound on the main winding (1), and a tap released so as to obtain different levels of induced voltage. Accordingly, the degree of the voltage raised and reduced is fixed and strictly limited due to the above.

However, the toroidal transformer of the present invention can obtain broader and more various levels of output voltage than the conventional one by forming secondary field windings (4a˜4d) on the primary field winding (2), and selectively adding the voltage to the primary field winding (2) by combining them.

If the turn of the secondary field windings (4a˜4d) increases and the sectional area of the core increases, a predetermined secondary field winding is wound on a separate core so as to obtain the same effect even when the remaining secondary field winding is wound on the toroidal core.

Also, secondary field windings (4a˜4d) can be formed in areas where the primary field winding (2) is not wound. That is, when a primary field winding (2) is wound, the primary field winding (2) is to be formed only in some areas of the toroidal core, and part of the secondary field windings (4a˜4d) is wound in the remainder. It is possible to wind the remaining secondary field windings to form a layer externally. If a sufficient amount of sectional area is not secured, predetermined secondary field windings (4a˜4d) can be wound on separate cores.

The present invention has precise voltage control to enable the output of the voltage level desired by the user, and a variety of applications for power saving and as a voltage booster. In particular, the present invention can adjust the voltage to the size of voltage corresponding to 1 [turn].

The present invention also comprises a simple relay switching circuit and excludes semiconductor switching devices, thereby being capable of operating adaptively in different system environments without an additional modification.

The present invention has been illustrated and described as embodied in the above examples. However, the present embodiments can be modified by a person having ordinary skill in the art without departing from the principle or spirit of the present invention. The scope of invention shall be defined by the attached claims and their equivalents.

1. An automatic voltage regulator for converting an input voltage applied to an input terminal and outputting the converted input voltage to an output terminal, comprising:
a main winding having one end thereof connected to the input terminal and the other end thereof connected to the output terminal;
a primary field winding excited in the main winding;
a first switch unit for selectively connecting one end of the primary field winding to either a reference potential or the output terminal;
a plurality of secondary field windings excited in the main winding;
a second switch unit for selectively switching so that the plurality of secondary field windings are selectively connected to the primary field winding serially, and that one or more of the plurality of secondary field windings are serially connected to each other to be serially connected to the other end of the primary field winding when the one or more of the plurality of secondary field windings are connected to the other end of the primary field winding;
a third switch unit for selectively connecting an end of a serial connection generated by selectively connecting the primary field winding and the secondary field windings to either the reference potential or the input terminal; and
a control unit which regulates the level of an output voltage outputted to the output terminal by switching control of the first switch unit, the second switch unit, and the third switch unit.

2. The automatic voltage regulator of claim 1, further comprising a level measurement unit for measuring the level of the input voltage inputted to the input terminal, and
wherein the control unit is configured to:
if a predetermined target voltage is higher than the level of the input voltage measured by the level measurement unit, control the first switch unit to connect the one end of the primary field winding to the reference potential, control the second switch unit to compensate for a voltage difference between the predetermined target voltage and the measured level of the input voltage, and control the third switch unit to connect the end of the serial connection to the input terminal, and
if the predetermined target voltage is lower than the level of the input voltage, control the first switch unit to connect the one end of the primary field winding to the output terminal, control the second switch unit to compensate for the voltage difference, and control the third switch unit to connect the end of the serial connection to the reference potential.

3. An automatic voltage regulator for converting an input voltage applied to an input terminal and outputting the converted input voltage to an output terminal, comprising:
a main winding;
a first switch unit for connecting one end of the main winding to either the input terminal or the output terminal;
a second switch unit for connecting the other end of the main winding to either the input terminal or the output terminal
a primary field winding excited in the main winding and having one end connected to the output terminal;
a plurality of secondary field windings excited in the main winding;
a third switch unit for selectively switching so that the plurality of secondary field windings are selectively connected to the primary field winding serially, and that one or more of the plurality of secondary field windings are serially connected to each other to be serially connected to the other end of the primary field winding when the one or more of the plurality of secondary field windings are connected to the other end of the primary field winding; and
a control unit which regulates the level of an output voltage outputted to the output terminal by switching control of the first switch unit, the second switch unit, and the third switch unit.

4. The automatic voltage regulator of claim 3, further comprising a level measurement unit for measuring the level of the input voltage inputted to the input terminal, and
wherein the control unit is configured to:
if a predetermined target voltage is higher than the level of the input voltage measured by the level measurement unit, control the first switch unit to connect the one end of the main winding to the output terminal, control the second switch unit to connect the other end of the main winding to the input terminal, and switch control the third switch to compensate for a voltage difference between the predetermined target voltage and the measured level of the input voltage, and
if the predetermined target voltage is higher than the level of the input voltage measured by the level measurement unit, control the first switch unit to connect the one end of the main winding to the input terminal, control the second switch unit to connect the other end of the main winding to the output terminal, and switch control the third switch to compensate for a voltage difference between the predetermined target voltage and the measured level of the input voltage.

5. The automatic voltage regulator of claim 1, further comprising a user input unit for inputting the predetermined target voltage from the user.

6. The automatic voltage regulator of claim 1, wherein the main winding is wound on a toroidal core, the primary field winding is wound to surround the main winding, and the secondary field windings are wound to surround the primary field winding.

7. The automatic voltage regulator of claim 1, wherein the main winding is wound on a toroidal core, the primary field winding is wound on the toroidal core to surround the main winding, one part of the plurality of secondary field windings are wound to surround the main winding by partitioning the primary field winding and the toroidal core, and the other part of the plurality of secondary field windings is wound to surround the primary field winding and the one part of the plurality of secondary field windings, which surround the main winding.

8. The automatic voltage regulator of claim 1, wherein the plurality of secondary field winding are wound in part on a second toroidal core.

9. The automatic voltage regulator of claim 1, wherein the sum of auxiliary voltages induced by exciting the plurality of secondary field windings is lower than the potential applied across the main winding.

10. The automatic voltage regulator of claim 1, wherein a selective addition using switching control of auxiliary voltages induced by exciting the plurality of secondary field windings may represent a voltage level lower than the potential applied across the main winding, and the voltage level corresponds to an integer number.

11. The automatic voltage regulator of claim 1, wherein the plurality of secondary field windings are wound to represent all the integer numbers of turns equal to or less than the maximum number of turns added by combining each of the turns of the plurality of secondary field windings.

12. The automatic voltage regulator of claim 11, the number of turns of at least a part of the plurality of secondary field windings is 2ⁿ⁻¹×10^{m-1}, wherein 1≦n≦4, m≧1, and n and m are integer numbers.

13. The automatic voltage regulator of claim 1, wherein the switch units are implemented with relays.

14. The automatic voltage regulator of claim 2, further comprising a fourth switch unit for switching the input terminal and the output terminal, and
wherein if a voltage difference between the predetermined target voltage and the level of the input voltage is within a predetermined permissible range, the control unit turns on the fourth switch unit to bypass the input voltage to the output terminal.

15. An automatic voltage regulator for converting an input voltage applied to an input terminal and outputting the converted input voltage to an output terminal, comprising:
a main winding having one end thereof connected to the input terminal and the other end thereof connected to the output terminal;
a primary field winding excited in the main winding and having one end thereof connected to the output terminal;
a plurality of secondary field windings excited in the main winding;
a switch unit for selectively switching so that the plurality of secondary field windings are selectively connected to the other end of the primary field winding serially, and that one or more of the plurality of secondary field windings are serially connected to each other to be serially connected to the other end of the primary field winding when the one or more of the plurality of secondary field windings are connected to the other end of the primary field winding; and
a control unit which regulates the level of an output voltage outputted to the output terminal by switching control of the switch unit.

16. An automatic voltage regulator for converting an input voltage applied to an input terminal and outputting the converted input voltage to an output terminal, comprising:
a main winding having one end thereof connected to the input terminal and the other end thereof connected to the output terminal;
a primary field winding excited in the main winding and having one end thereof connected to a reference potential;
a plurality of secondary field windings excited in the main winding;
a switch unit for selectively switching so that the plurality of secondary field windings are selectively connected to the other end of the primary field winding serially, and that one or more of the plurality of secondary field windings are serially connected to each other to be serially connected to the other end of the primary field winding when the one or more of the plurality of secondary field windings are connected to the other end of the primary field winding; and
a control unit which regulates the level of an output voltage outputted to the output terminal by switching control of the switch unit.

17. The automatic voltage regulator of claim 15, wherein the main winding is wound on a toroidal core, the primary field winding is wound to surround the main winding, and the secondary field windings are wound to surround the primary field winding.

18. The automatic voltage regulator of claim 15, wherein the main winding is wound on a toroidal core, the primary field winding is wound on the toroidal core to surround the main winding, one part of the plurality of secondary field windings are wound to surround the main winding by partitioning the primary field winding and the toroidal core, and the other part of the plurality of secondary field windings is wound to surround the primary field winding and the one part of the plurality of secondary field windings, which surround the main winding.

19. The automatic voltage regulator of claim 15, further comprising a level measurement unit for measuring the level of the input voltage inputted to the input terminal, and
wherein the control unit is configured to switch control the switch unit so as to compensate for a voltage difference between a predetermined target voltage and the measured level of the input voltage.

20. A transformer using a toroidal core comprising:
a main winding wound on the toroidal core, and having one end to which an input voltage is inputted;
a primary field winding wound on the toroidal core on which the main winding is wound, and excited in the main winding;
a plurality of secondary field windings wound on the primary field winding, and excited by the main winding;
a switch unit for selectively connecting the plurality of secondary field windings to the primary field winding serially; and
a control unit for controlling switching operations of the switch unit.

21. A transformer using a toroidal core comprising:
a main winding wound on the toroidal core, and having one end to which an input voltage is inputted;
a primary field winding wound on the toroidal core on which the main winding is wound, and excited in the main winding;
a plurality of secondary field windings excited in the main winding, wherein one part of the plurality of secondary field windings are wound on an area where the primary field winding is not wound, and the other part of the plurality of secondary field windings are wound to surround the primary field winding and the one part of the plurality of secondary field windings;
a switch unit for selectively connecting the plurality of secondary field windings to the primary field winding serially; and
a control unit for controlling switching operations of the switch unit.
